(19) United States
(12) Patent Application Publication
(10) Pub. No.: US 2026/0116407 A1
(43) Pub. Date: Apr. 30, 2026

(54) VEHICLE CONTROL SYSTEM THAT SETS MAXIMUM SPEED AND GEOFENCING UPON DRIVER EXISTING THE VEHICLE

(71) Applicant: Volvo Car Corporation, Göteborg (SE)

(72) Inventors: Hossein Soleimani, Gothenburg (SE); Bhavesh Patel, Gothenburg (SE); Balaji Vadivel, Gothenburg (SE); Divya Ravikumar, Gothenburg (SE); Ping Gong, Gothenburg (SE)

(21) Appl. No.: 18/928,862

(22) Filed: Oct. 28, 2024

(51) Int. Cl. B60W 50/08; B60R 25/20; B60W 30/14

(52) U.S. Cl. CPC B60W 50/085; B60W 30/146; B60R 25/20; B60W 2540/043; B60W 2720/10

(57) ABSTRACT

A system, comprises: one or more sensors integrated on or within a vehicle; a memory that stores computer executable components; and a processor that executes the computer executable components stored in the memory, wherein the computer executable components comprise: a communication interface component that receives a command from the driver as the driver exits the vehicle; a speed limiter component that defines a maximum speed value the vehicle can operate based on the received command; a geofencing component that defines geographic boundaries for the vehicle operation based on the received command; and a control component operatively connected to the communication interface component, speed limiter component and the geofencing component, wherein the control component activates the speed limiter component to utilizes the maximum speed value and activates the geofencing component to determine the geofencing boundaries to limit the functionality of the vehicle based on the driver's command.

### TECHNICAL FIELD

The disclosed subject matter relates to vehicles (e.g., transportation vehicles), and more particularly, to controlling vehicle access and usage functionality based on voice command and driver associated with the voice command.

### BACKGROUND

Many times, the driver of a vehicle allows other drivers to temporarily use the driver's vehicle. For example, a valet parking attendant. However, the driver does not know how the driver will use the vehicle. The driver does not have the means to limit the use of the vehicle so that the valet parking attendant does not abuse the vehicle by speeding or spinning out the tires by accelerating too fast. Also, once the owner of the vehicle is out of sight, the valet parking attendant can open the glove box, truck, or hood to steal items or rummage through the private stuff. Since the valet parking attendant has the key fob, the attendant can also go through the driver's driving history, including the driver's home address, as well as commonly visited places. This can be dangerous if the attendant or others invades the owner's home the car is parked.

Valet parking is a useful service. However, there are many things that can be abused if not controlled. However, the driver cannot anticipate all the type so abuses a valet parking attendant would do while the vehicle is under their control. Thus, a smart system is needed to allow the driver to provide method of control what is useful and convenient.

### SUMMARY

The following presents a summary to provide a basic understanding of one or more embodiments of the invention. This summary is not intended to identify key or critical elements or delineate any scope of the embodiments or any scope of the claims. Its sole purpose is to present concepts in a simplified form as a prelude to the more detailed description that is presented later. In one or more embodiments described herein, systems, devices, computer-implemented methods, apparatuses and/or computer program products that facilitate road hazard contact mitigation are described.

According to an embodiment, a system can comprise one or more sensors integrated on or within a vehicle; a memory that stores computer executable components; and a processor that executes the computer executable components stored in the memory, wherein the computer executable components comprise: a communication interface component that receives a command from the driver as the driver exits the vehicle; a speed limiter component that defines a maximum speed value the vehicle can operate based on the received command; a geofencing component that defines geographic boundaries for the vehicle operation based on the received command; and a control component operatively connected to the communication interface component, speed limiter component and the geofencing component, wherein the control component activates the speed limiter component to utilizes the maximum speed value and activates the geofencing component to determine the geofencing boundaries to limit the functionality of the vehicle based on the driver's command.

According to another embodiment, a method can comprise receiving, by a communication interface component, a command from the driver as the driver exits the vehicle; defining, by a speed limiter component, a maximum speed value the vehicle can operate based on the received command; determining, by a geofencing component, a geographic boundary for the vehicle operation based on the received command; and controlling, by a control component operatively connected to the communication interface component, speed limiter component and the geofencing component, operations of the speed limiter component to activate speed limit and operations of the geofencing component to limit operation of the vehicle within the geographic boundary.

According to another embodiment, a non-transitory machine-readable medium can comprise executable instructions that, when executed by a processor, facilitate performance of operations, comprising: receiving a command from the driver as the driver exits the vehicle; defining a maximum speed value the vehicle can operate based on the received command; determining a geographic boundary for the vehicle operation based on the received command; and controlling operations of the speed limiter component to activate speed limit and operations of the geofencing component to limit operation of the vehicle within the geographic boundary.

### BRIEF DESCRIPTION OF DRAWINGS

FIG. 1 illustrates a block diagram of an exemplary system that facilitates controlling vehicle access and usage functionality based on user command and other authentication methods, in accordance with one or more embodiments described herein.

FIG. 2 illustrates a block diagram of example computer-executable components of an onboard computer system of a vehicle that facilitate controlling vehicle access and usage functionality, in accordance with one or more embodiments described herein.

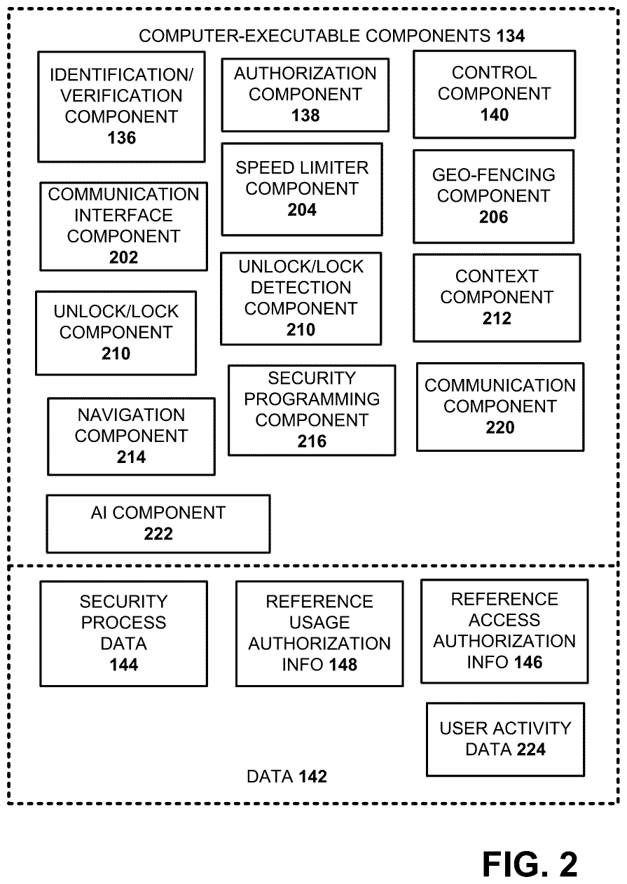

FIG. 3 illustrates a block flow diagram of an example, non-limiting computer-implemented method for controlling vehicle access and usage functionality, in accordance with one or more embodiments described herein.

FIG. 4 illustrates a block flow diagram of an example, non-limiting computer-implemented method for controlling vehicle access and usage functionality, in accordance with one or more embodiments described herein.

FIG. 5 illustrates a block flow diagram of an example, non-limiting computer-implemented method for controlling vehicle access and usage functionality, in accordance with one or more embodiments described herein.

FIG. 6 illustrates a block flow diagram of an example, non-limiting computer-implemented method for controlling vehicle access and usage functionality, in accordance with one or more embodiments described herein.

FIG. 7 illustrates a block flow diagram of an example, non-limiting computer-implemented method for controlling vehicle access and usage functionality, in accordance with one or more embodiments described herein.

FIG. 8 illustrates a block flow diagram of an example, non-limiting computer-implemented method for controlling vehicle access and usage functionality, in accordance with one or more embodiments described herein.

FIG. 9 is an example, non-limiting computing environment in which one or more embodiments described herein can be implemented.

FIG. 10 is an example, non-limiting networking environment in which one or more embodiments described herein can be implemented.

### DETAILED DESCRIPTION

The following detailed description is merely illustrative and is not intended to limit embodiments and/or application or uses of embodiments. Furthermore, there is no intention to be bound by any expressed or implied information presented in the preceding Background or Summary sections, or in the Detailed Description section.

One or more embodiments are now described with reference to the drawings, wherein like referenced numerals are used to refer to like elements throughout. In the following description, for purposes of explanation, numerous specific details are set forth to provide a more thorough understanding of one or more embodiments. It is evident, however, in various cases, that one or more embodiments can be practiced without these specific details.

It will be understood that when an element is referred to as being “coupled” to another element, it can describe one or more different types of coupling including, but not limited to, chemical coupling, communicative coupling, capacitive coupling, electrical coupling, electromagnetic coupling, inductive coupling, operative coupling, conductive coupling, acoustic coupling, ultrasound coupling, optical coupling, physical coupling, thermal coupling, and/or another type of coupling. As referenced herein, an “entity” can comprise a human, a client, a user, a computing device, a software application, an agent, a machine learning model, an artificial intelligence, and/or another entity. It should be appreciated that such an entity can facilitate implementation of the subject disclosure in accordance with one or more embodiments described herein.

The computer processing systems, computer-implemented methods, apparatus, and/or computer program products described herein employ hardware and/or software to solve problems that are highly technical in nature (e.g., mitigate road hazard contact), that are not abstract and cannot be performed as a set of mental acts by a human.

In various embodiments described herein, when a driver hands off a key to a valet parking attendant, the vehicle's integrated system can be configured to ensure security and safety through specific limitations. The driver can issue a command to notify the vehicle control system that the next driver is a valet parking attendant. The control system can now set a maximum speed limit (e.g., 10-15 mph) to prevent the valet from driving recklessly. Additionally, the system can use GPS technology to define a geographical area, restricting the vehicle's operation within a predefined boundary (e.g., route set to and from parking spot). This ensures the car remains within the vicinity of the parking facility, preventing unauthorized use or theft. These features offer peace of mind to the driver, knowing that the vehicle is secure and will be handled responsibly by the valet. In addition, the system can perform a verification of the valet driver's credentials and retrieve driving history to implement additional limitations.

For example, once the person has been identified and verified, the onboard computer system of the vehicle can determine whether the person is authorized to access the vehicle, and controls access accordingly via unlocking and locking respective enclosures of the vehicle. For example, the onboard computer system of the vehicle can store (e.g., in memory thereof) access authorization information linking defined user identities (e.g., usernames, unique identifiers, etc.) to access permissions. The access permissions can be tailored to one or more specific compartments or of the vehicle (e.g., the main cabin and the trunk for instance). For example, the access permissions may allow a first user identity to access all compartments of the vehicle and a second user identity to access only the trunk of the vehicle. The access permissions can also be tailored based on context (e.g., time of day, day of week, location, and other contextual parameters). For example, the access permissions may allow a first user identity to access all compartments of the vehicle under any contexts and a second user identity to access only the trunk of the vehicle over a defined time window.

In some embodiments, in addition to controlling access to the vehicle based on verifying that the person is authorized to do so, the onboard computer system of the vehicle can also control usage of one or more functionalities of the vehicle based on the identity of the person. For example, the onboard computer system of the vehicle can store (e.g., in memory thereof) usage authorization information linking defined user identities (e.g., biometric data, usernames, unique identifiers, etc.) to vehicle usage permissions. In this regard, the usage permissions can relate to one or more operating functionalities of the vehicle that the user is authorized (or not authorized) to utilize, such as the driving functionality of the vehicle, the heating/ventilation and cooling (HVAC) system of the vehicle, the infotainment system of the vehicle, and so on. For example, the usage permissions may allow one user to enter and employ the driving functionality of the vehicle and another user to only access the vehicle to retrieve something yet not use the driving functionalities of the vehicle. The onboard computer system of the vehicle can further automatically control activation and deactivation of the operating functionalities of the vehicle in accordance with the usage permissions. For example, the onboard computer system can automatically start the vehicle or enable the user to start the vehicle (e.g., via a push button located inside the vehicle or the like) based on the user having permission to start the vehicle.

In some implementations, the usage permissions can also be tailored based on context (e.g., time of day, day of week, location, and other contextual parameters). For example, the usage permissions can restrict usage of the driving functionality of the vehicle to a particular identity based on a particular context (e.g., time of day, day of week, location, route, speed, etc.). In some implementations, the usage permissions can also include or correspond to settings regarding preferences of the identity with respect to various features and functionalities of the vehicle and the onboard computer system can automatically configure the features and functionalities in accordance with the settings for a given usage scenario by an authorized identity. For example, the settings information can relate to settings of any onboard vehicle system or device that can be electronically controlled by the onboard computer system of the vehicle, such as seat position settings, HVAC settings, infotainment settings, navigation/route settings, and so on.

In some embodiments, the disclosed techniques can also incorporate artificial intelligence (AI) to facilitate inferring access permissions, usage permissions, and settings preferences for one or more people with respect to a vehicle based on historical access and usage of the vehicle under different contexts.

In some embodiments, the disclosed techniques can also enable one or more authorized users to grant and define access and usage permissions for a vehicle using a suitable onboard user interface coupled to the onboard computer system of the vehicle (e.g., a touchscreen coupled to the infotainment system or the like) and/or using an external system or device communicatively coupled to the onboard computer system of the vehicle via one or more wired or wireless communication networks.

One or more embodiments are now described with reference to the drawings, wherein like referenced numerals are used to refer to like elements throughout. In the following description, for purposes of explanation, numerous specific details are set forth in order to provide a more thorough understanding of one or more embodiments. It is evident, however, in various cases, that one or more embodiments can be practiced without these specific details.

It will be understood that when an element is referred to as being “coupled” to another element, it can describe one or more different types of coupling including, but not limited to, chemical coupling, communicative coupling, capacitive coupling, electrical coupling, electromagnetic coupling, inductive coupling, operative coupling, conductive coupling, acoustic coupling, ultrasound coupling, optical coupling, physical coupling, thermal coupling, and/or another type of coupling. As referenced herein, an “entity” can comprise a human, a client, a user, a computing device, a software application, an agent, a machine learning model, an artificial intelligence, and/or another entity. It should be appreciated that such an entity can facilitate implementation of the subject disclosure in accordance with one or more embodiments described herein.

The vehicles computer processing systems, computer-implemented methods, apparatus and/or computer program products described herein employ hardware and/or software to solve problems that are highly technical in nature (e.g., mitigate road hazard contact), that are not abstract and cannot be performed as a set of mental acts by a human.

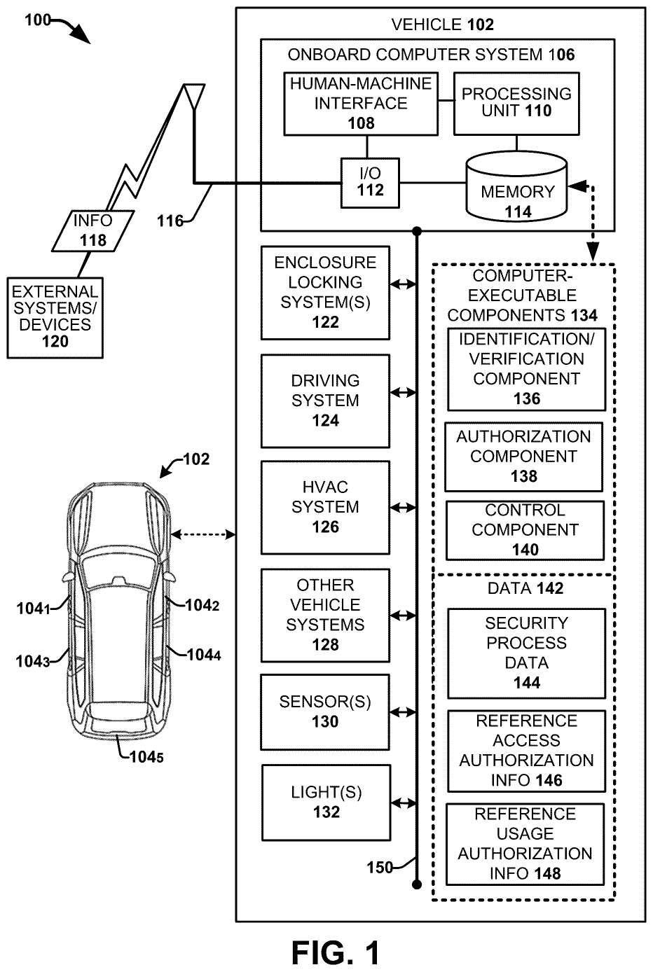

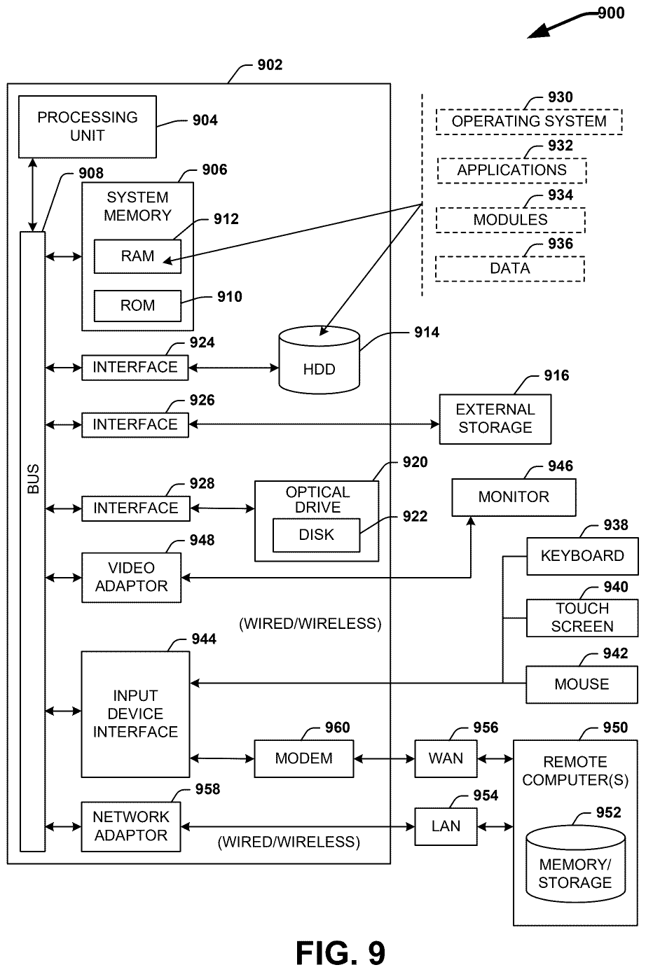

Turning now to the drawings, FIG. 1 illustrates a block diagram of an exemplary system 100 that facilitates controlling vehicle access and usage functionality based on user authentication using facial recognition and other authentication methods, in accordance with one or more embodiments described herein. System 100 comprises a vehicle 102 with an onboard computer system 106 and comprising a memory 114 that stores computer-executable components 134 and data 142 that facilitate controlling access and one or more functionalities of the vehicle based on receiving drivers voice command and user authentication using facial/voice recognition and other authentication methods disclosed herein. The onboard computer system 106 includes at least one processor or processing unit 110 that executes the computer-executable component 134 stored in memory 114 to carry out the operations/functions described with respect to the corresponding computer-executable components. Examples of said memory 114, processing units 110, and other computer system components that can be included in the onboard computer system 106 to facilitate the various features and functionalities of system 100 can be found with reference to FIG. 9 (e.g., system memory 910, processing unit 904, and the like).

The onboard computer system 106 can further include an input/output (I/O) component 112, wherein the I/O component 112 can be a transceiver configured to enable transmission/receipt of information 118 between the onboard computer system 106 and various external systems or devices 120. For example, the external systems or devices 120 can correspond to any type of device or computing system configured to wirelessly communicate (e.g., using radio frequency signals) with the onboard computer system 106, such as but not limited to, a mobile device associated with one or more users of the vehicle 102 (e.g., a smartphone, a smartwatch, a tablet, or another type of wearable device), an external computer, an external computer system, an external application server, another vehicle's onboard computer system, and so on. The I/O component 112 can be communicatively coupled, via an antenna 116, to the remotely located devices and systems (e.g., external systems/devices 120). Any suitable technology can be utilized to enable the various embodiments presented herein, regarding transmission and receiving of information 118 between the onboard computer system 106 and one or more external systems/devices 120. Suitable technologies include BLUETOOTH®, cellular technology (e.g., 3G, 4G, 5G), internet technology, ethernet technology, ultra-wideband (UWB), DECAWAVE®, IEEE 802.15.4a standard-based technology, Wi-Fi technology, Radio Frequency Identification (RFID), Near Field Communication (NFC) radio technology, and the like.

The onboard computer system 106 can also include a human-machine interface 108 that provides for receiving user input in association with utilizing the various features and functionalities of the computer-executable component 134 and presenting information to users. For example, the human-machine interface 108 can include or correspond to any suitable output device such as a display, a speaker, etc. and any suitable input device, such as a touchscreen display, a microphone, a keypad, a keyboard, and the like. Examples of suitable input and output devices of the human-machine interface 108 devices are further provided with reference to FIG. 9.

Vehicle 102 can correspond to any type of vehicle comprising one or more internal compartments (e.g., the main cabin, the trunk, and other types of compartments) that are accessed via one or more enclosures 104₁₋₅ (e.g., doors, passenger doors, a hood enclosure, a trunk enclosure, etc.) that can be electrically locked and unlocked by the onboard computer system 106 (e.g., via control component 140) and one or more respective enclosure locking systems 122 coupled thereto. For instance, vehicle 102 can include or correspond to any type of motor vehicle (e.g., a car, a truck, a van, a sport utility vehicle (SUV), etc.). In some implementations vehicle 102 can also include or correspond to an aircraft (e.g., an airplane, a helicopter, or the like), a watercraft, or another type of passenger transportation vehicle. In some embodiments, vehicle 102 can include or correspond to an autonomous vehicle that is capable of navigating and operating without (or some) human input.

In this regard, vehicle 102 can comprise various electrical and electromechanical systems that are coupled to the onboard computer system 106 via a system bus 150 (and/or via any suitable wired or wireless communication technology), including but not limited to, one or more enclosure locking systems 122, a driving system 124, an HVAC system 126 and various other vehicle systems 128 (e.g., an infotainment system, a navigation system, and autonomous driving system, and so on). Vehicle 102 can also include one or more sensors 130 and lights 132 coupled to the onboard computer system 106 that facilitate various features and functionalities of the computer-executable components 134 described below.

The one or more enclosure locking systems 122 can include or correspond to electromechanical locking devices that are coupled to the respective enclosures 104₁₋₅ and that mechanically lock to prevent the respective enclosures from being opened, and mechanically unlock to enable the respective enclosures to be opened, via corresponding electrical control signals applied thereto by the onboard computer system 106 (e.g., via control component 140).

In accordance with various embodiments, the onboard computer system 106 can provide a keyless entry functionality for vehicle 102 based on authenticating a person accessing or attempting to access one or more internal compartments of the vehicle via one or more of the enclosures 104₁₋₅. In other words, the onboard computer system 106 can control locking and unlocking of the respective enclosures without usage of a physical key or external device such as a key fob or the like. More particularly, the onboard computer system 106 can control locking and unlocking of the respective enclosures based on authentication of the person or persons attempting to access the vehicle 102 based on biometric data captured of the person or persons at the time of attempted or requested access via one or more sensors 130 integrated on or within the vehicle. To facilitate this end, the computer-executable be components can include (but are not limited to) identification/verification component 136, authorization component 138, and control component 140.

In one or more embodiments, the identification/verification component 136 can perform an entity identification/verification process (e.g., as defined in security process data 144) to identify and verify an identity of a person desiring (or presumably desiring) to access one or more internal compartments of the vehicle 102 based on biometric data captured of the person via at least one sensor of the one or more sensors 130 and reference identity verification data for one or more defined identities. For example, the reference identity verification data can be stored in memory 114 (e.g., as included in reference access authorization information 146) and provide corresponding reference biometric data for one or more defined identities. For instance, the reference access authorization information 146 can include or correspond to an index defining one or more user identities (e.g., as defined using unique identifiers for the respective identities, such as names, usernames, identification numbers, etc.) and includes registered biometric data for the respective user identities that can be used to uniquely identify the respective users (e.g., one or more facial images, one or more voice samples and/or voice signatures, one or more fingerprint signatures, one or more iris/retina signatures, etc.) in accordance with the entity identification/verification process used (e.g., a facial recognition process, a voice recognition process, or another processes involving other identity verification/authentication checks). In this regard, and the identification/verification component 136 can identity and verify the identity of a person attempting to access the vehicle 102 based on matching (e.g., relative to a defined degree of similarity) of currently captured biometric data of a person (via the one or more sensors 130) with corresponding reference biometric data for the person stored in memory 114.

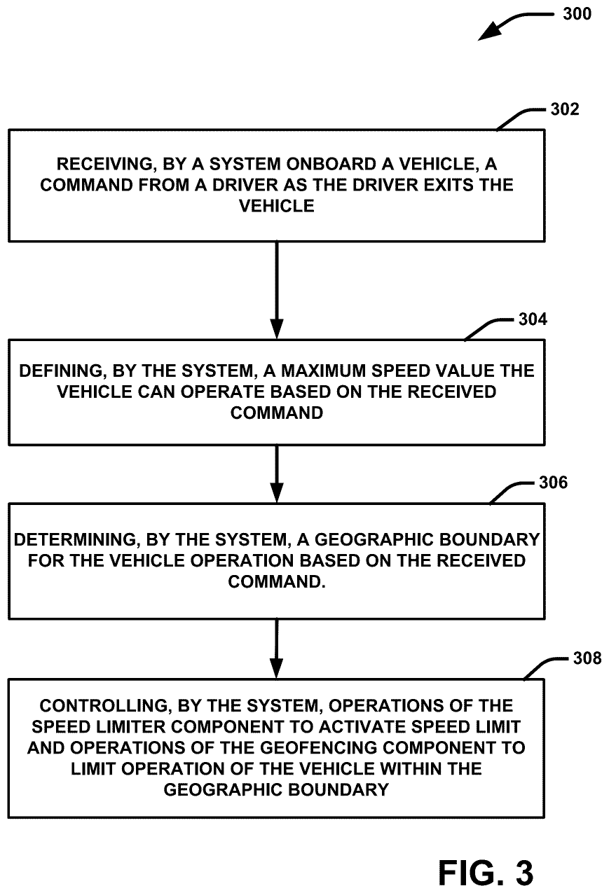

The authorization component 138 further determines access authorization information regarding whether the person is authorized to access one or more internal compartments of the vehicle 102 based on verification of the identity of the person in accordance with the entity identification/verification process and reference access authorization information 146 defining access permissions for the one or more defined identities. For example, reference authorization information 146 can further indicate whether each identity is authorized to access one or more internal compartments of the vehicle or not. In some embodiments, the access can be tailored to one or more different internal compartments of the vehicle (e.g., all internal compartments, the main cabin only, the trunk only, and so on). With these implementations, the reference access authorization information 146 can also define which internal compartment each identity is authorized to access. Still in other embodiments, the access can be restricted based on context and the reference access authorization information 146 can define any contextual restrictions on access of each defined identity (e.g., as described in greater detail infra with reference to FIG. 3).

The control component 140 further controls access to the one or more internal compartments via electronically controlling unlocking and locking of corresponding enclosures of the one or more internal compartments (e.g., via issuing corresponding unlocking/locking control signals to the corresponding enclosure locking systems 122 coupled to the enclosures) in accordance with the reference access authorization information defined for the person/identity. For example, based on a determination by the authorization component 138 that an identified and verified person desiring to access one or more compartments of the vehicle is authorized to do so (e.g., as defined in the reference access authorization information 146), the control component 140 can unlock the one or more enclosures to the corresponding compartments.

In various embodiments, the biometric data used to identify and verify the identity of a person desiring to unlock one or more doors of the vehicle 102 comprises facial image data of the person and the identification/verification process performed by the identification/verification component 136 comprise a facial recognition process. With these embodiments, the one or more sensors 130 can include at least one camera configured to capture the facial image data of the person in association with detecting the person desires to access the vehicle 102. In various embodiments, the camera can include or correspond to one or more existing cameras integrated on or within the vehicle that are used for other functions and/or systems of the vehicle, such as a back-up camera, one or more autonomous navigation system cameras, or the like. In other embodiments, the camera can include or correspond to a camera positioned on or within the vehicle that provides a natural line of sight to the position of a person's face as located outside of the vehicle (e.g., as tailored based on the person's height and/or distance from the vehicle 102).

FIG. 3 illustrates a block diagram of example computer-executable components 134 of the onboard computer system 106 of vehicle 102 that facilitate controlling vehicle access and usage functionality, in accordance with one or more embodiments described herein. As shown in FIG. 3, in some embodiments, in addition to the identification/verification component 136, the authorization component 138 and the control component 140, the computer-executable components 134 can also include a communication interface component 202, a speed limiter component 204 and geofencing component 206.

In various embodiments, the communication interface component 202 is configured to receive a voice command from the driver and can determine or facilitate determining what the driver said as the driver exists the vehicle. Using a sensor component (not shown), control component 140 can determine that the driver has existed the vehicle (e.g., seat pressure sensor indicates no one is seating in the driver seat). In an embodiment, the system determines if the driver had provided any commands prior to existing the vehicle. For example, if the driver indicated, by providing a voice command, that a valet parking attendant will be operating the vehicle, then the control system determines that the next driver will be the valet. In another embodiment, the driver can provide a command (e.g., a phrase including “valet”) as the driver exists the vehicle or after the driver has existed the vehicle. This command can be provided via the key fob or directly to the vehicle that is in listening mode upon driver existing the vehicle. In an aspect, the key fob is configured to receive a voice command that is transmitted to the communication interface component 202. The transmission of the command from the key fob can occur immediately if the key fob is in communication with the communication interface component 202 or upon connecting to the communication interface component 202 later. For example, in accordance with some embodiments the driver can exist the vehicle and provide a phrase (e.g., any phrase containing “valet”) using a key fob, vehicles microphone, external devices, infotainment system that is determined by the communication interface component has receiving a command from the driver indicating that the next driver will be valet. In some embodiments, the driver may provide a command, using an infotainment of the vehicle or an external device (e.g., phone), information about the next driver. In an aspect, the communication interface component 202 further receives the override command to temporarily increase the maximum speed value or deactivate speed limits and geofencing limits.

In various embodiments, the speed limiter component 204 receives an indication from one of the computer-executable components 134 indicating that the next driver is a valet. After various authentication and verifications, the speed limiter defines a maximum speed value that vehicle can operate (e.g., the maximum speed limit value can be set to 15 mph). The maximum speed limit value is provided to the control component 140 that used this value to set maximum speed limit of the vehicle to the maximum speed limit value.

In various embodiments, the geofencing component 206 defines the geographic boundaries for the vehicle operation. In an aspect, upon receiving an indication from the control component that the next driver is a valet, the geofencing component 206 using current location, the most efficient route to a parking lot used by the valet and displays the route on the display of the vehicle. Geofencing component 206 initiates monitoring of the vehicle's location and provides an alert to the owner/driver if the vehicle location is goes off selected route. In some embodiments, the geofencing component 206 determines the route based on maximum speed value and location of the parking lot to determine the optimal route that would allow the valet to operate the vehicle within the maximum speed limit. Geofencing component 206 may notify the driver if the maximum speed limit needs to be adjusted based on speed limit requirements along the selected route. In an aspect, the geofencing component 206 calculates a route that is used to determine the geofencing boundaries, the route is based on a current location value and a parking structure location value.

In various embodiments, the control component 140, operatively connected to the communication interface component 202, the speed limiter 304 and the geofencing component 206 to facilitate operation of the vehicle with a geographical boundary with a maximum speed limit. The control component 140 activates the speed limiter component 204 to utilizes the maximum speed value and activates the geofencing component 206 to determine the geofencing boundaries to limit the functionality of the vehicle based on the driver's command. In some embodiments, the control component 140 restricts access to one or more components of the vehicle. For example, control component 140 restricts access to a glove compartment, hood release and trunk release when an override command is not provided. In some embodiments, control component 140 restricts access to the vehicle's trunk, the vehicle's hood, a glove compartment, an infotainment system, vehicle's GPS history and one or more electronic components of the vehicle. In an aspect, the control component 140 further controls access to the one or more internal compartments via electronically controlling unlocking and locking of an enclosure of the one or more internal compartments in accordance with an access authorization information determined based on the command. In an aspect, wherein the control component 140 deactivates the speed limiter component and geofencing component upon receiving a deactivation signal from the communication interface component 202.

In some embodiments, in addition to the identification/verification component 136, the authorization component 138, a communication interface component 202, a speed limiter component 204 and geofencing component 206, the computer-executable components 134 can also include a communication interface component 202, a speed limiter component 204 and geofencing component 206, the computer-executable components 134 can also include unlock/lock detection component 210, context component 212, navigation component 214, security programming component 216 and communication component 220.

In some embodiments, the unlock/lock detection component 210 can determine or facilitate determining when a person external to the vehicle 102 desires to unlock and lock respective enclosures of the vehicle 102. For example, in accordance with some embodiments in which facial recognition and/or other biometric based user identity/verification mechanisms are employed to unlock one or more enclosures to the vehicle, as a person approaches the vehicle in locked state and becomes within a defined distance relative to the vehicle 102, the identification/verification component 136 can automatically initiate the identification/verification process and unlock the vehicle based on identification/verification of the identity of the person and a determination (e.g., via the authorization component 138) that the identity is authorized to access the vehicle. For example, using one or more proximity sensors, motion sensors, cameras or the like, the unlock/lock detection component 210 can detect a person approaching the vehicle and direct the corresponding biometric sensors (e.g., cameras, acoustic sensors, etc.) to capture the biometric data for the person (e.g., image data, facial image data, voice data, iris/retina data, etc.), and the identification/verification component 136 can perform the identification/verification process using the captured biometric data in order to automatically unlock the vehicle // authorized for the person.

However, in accordance with these embodiments, it can be appreciated that users authorized to access the vehicle may be positioned within the defined distance of the vehicle yet not desire to have the vehicle automatically unlocked, such as when they are leaving the vehicle and desire for the vehicle to remain locked, walking past the vehicle or the like. Likewise, it can be appreciated that activating the camera and other biometric sensors in response to detection of any person (or object other than a person), including unauthorized persons within the defined distance of the vehicle, to capture biometric data and performing the identification/verification process to potentially unlock the vehicle can be a wasteful utilization of the sensor's power supply and computing resources (e.g., processing power and power supply) of the onboard computer system 106, especially in scenarios in which the vehicle is located in high pedestrian traffic areas (e.g., busy parking lots or the like).

Thus, in various embodiments, the unlock/lock detection component 210 can provide one or more mechanisms to control activation of the requisite biometric data capturing sensors of the vehicle 104 and performance of the identity/verification process in association with utilization thereof to unlock the vehicle to restrict activation and performance to scenarios in which a person clearly desires to unlock the vehicle. With these embodiments, the security process data 144 can define conditions and/or signals that correspond to a request to unlock the vehicle (or more particularly one or more enclosures thereof), and the unlock/lock detection component 210 can determine when a person is requesting to unlock the vehicle when the conditions/signals are met or otherwise received. With these embodiments, in response to a determination by the unlock/lock detection component 210 that a person external to the vehicle 102 desires to unlock and one or more enclosures of the vehicle, the unlock/lock detection component 210 can direct the identification/verification component 136 to initiate performance of the entity identification/verification process in association with utilization thereof to unlock the vehicle. This can involve temporarily activating necessary sensors (of the one or more sensors 122) to capture the requisite biometric data used by the identification/verification component 136 to identify and verify the identity of the person in accordance with the applicable entity identification/verification process.

Likewise, in some implementations, in response to a determination that the vehicle should be locked, the unlock/lock detection component 210 can direct the control component 140 to lock the respective enclosures of the vehicle. In some embodiments, the control component 140 can be configured to automatically lock the vehicle unless an explicit request to unlock the vehicle is received. The control component 140 can also be configured to automatically lock the vehicle based on defined conditions or criteria being met (e.g., as determined via the unlock/lock detection component 210 based on monitoring the vehicle 102 environment and context via the one or more sensors 130 and/or other contextual data input), such as following a defined time window after unlocking, following closing of the enclosure or enclosures after unlocking an opening thereof, following exiting of the vehicle by respective passengers, and other contextual-based criteria, events or conditions.

Various conditions and/or signals can be employed to indicate when a person external to vehicle 102 desires to unlock one or more enclosures of the vehicle 102. In some embodiments, the conditions or signals can correspond to a person approaching and facing the vehicle and becoming a defined distance relative to the vehicle or one or more enclosures of the vehicle). Additionally, or alternatively, the conditions or signals can correspond to touching, pointing to, or otherwise engaging a handle (e.g., a door handle) of a locked enclosure, as detected by the unlock/lock detection component 210 using one or more contact sensors integrated on or within the door handles, motion sensors, and/or cameras (e.g., included in the one or more sensors 130). For example, in some implementations of these embodiments, the respective door handles can include contact sensors. In other implementations, motion sensors can be used to detect motion nearby the vehicle, which in turn can cause the onboard computer system 106 to activate one or more cameras with a perspective of the environment around the vehicle to capture image data of the environment which. The sensory data can be analyzed via the unlock/lock detection component 210 using various object localization and/or tracking mechanism to determine relative object position, object movement, orientation and so on. For example, the unlock/lock detection component 210 can analyze the image data to determine whether a person around the vehicle desires to unlock the vehicle based on the person touching, pointing to, or otherwise engaging a handle (e.g., a door handle) of an enclose in the captured image data.

In other implementations, motion sensors can be used to detect motion nearby the vehicle, which in turn can cause the onboard computer system 106 to activate one or more cameras with a perspective of the environment around the vehicle and/or other sensors configured to capture sensory data. With these implementations, an expressed signal in the form of a voice command, gesture, sequence of gestures, and/or body position of the person relative to the vehicle (e.g., such as standing at a particular position relative the vehicle and facing the camera, a microphone or the like), or the like, can be used to indicate a request unlock the vehicle.

In some embodiments, the unlock/lock detection component 210 can also control activation of one or more lights 132 integrated on or within the vehicle in association with capturing image data of the external environment of the vehicle 102 (e.g., via camera and/or other cameras integrated on or within the vehicle) in contexts in which the external environment is dimply lit or dark (e.g., relative to a defined degree of brightness). For example, in association with activating the one or more cameras to capture facial image data of a person in the external environment and/or other image data of the external environment in dark or dimply lit conditions, the unlock/lock detection component 210 can temporarily activate one or more lights 132 to improve the brightness and quality of the image data captured.

As noted above, in some embodiments, various features and functionalities of the identification/verification component 136 and the authorization component 138 can be tailored based on context. In this regard, in some embodiments, the particular identity/verification processes to be applied by the identification/verification component 136 can be tailored based on context (e.g., time of day, day of week, location of the vehicle, weather, and other contextual factors). In other words, the security process data 144 can define different security processes to be used for different context in association with enabling/disabling access to the vehicle and/or enabling/disabling various usage functionalities of the vehicle for an authenticated person, depending on the context of the vehicle 102. The different security processes can vary with respect to the number and/or type of security checks applied so as to provide different levels of security under different contexts. For example, in some implementations, the security process data 144 can define a heighted identity/verification process for locations of the vehicle other than a vehicle user's home location, and/or for geographical locations classified as high crime risks or otherwise associated with a high-risk event (e.g., a current/recent criminal event at or near the location or the like). For instance, a low or moderately robust identity/verification process based on one or two different identity/verification checks (e.g., facial recognition based, voice recognition based, etc., verbal/gesture-based password based, etc.) may be applied for defined low risk locations, and more robust identity/verification process (providing a higher level of security) based on higher number of identity/verification checks may be applied for defined high risk locations. In another example, the context can be based on time of day, day of week, weather, and other contextual factors. For instance, the other contextual factors can account for the current external environment of the vehicle, including but not limited to, a level of activity in the environment a number of people in the environment, a number of unauthorized people in the environment, and so on (e.g., wherein the level of security associated with security process employed can increase relative to the level of activity, number of people, number of unauthorized people, etc.). In another example, in scenarios in which the weather conditions are not conducive for a user of the vehicle to perform a robust identity/verification process involving multiple security checks (and thus a longer duration of time) to unlock and enter their vehicle (e.g., when it's raining, snowing, extremely high/low temperatures, etc.), a more speedy identity/verification process can be automatically applied (e.g., based on a single security check, such as facial recognition only or provision of a verbal/gesture based password only).

The reference access authorization information 146 defined for one or more users of the vehicle 102 can also be tailored based on context. In this regard, as described above, different users of vehicle 102 can have different access permissions with respect to which internal compartments they are authorized to access (e.g., all internal compartments, the main cabin only, the trunk only, and so on). In addition, the reference access authorization information 146 defined for a particular user identity of the vehicle 102 can vary based on context, such as vehicle location, time of day, day of week, weather, the external environment of the vehicle, other contextual factors. For example, reference access authorization information 146 defined for a particular user identity may restrict access to one or more internal compartments of the vehicle as a function of a location of the vehicle, a timeframe, or the like.

The reference usage authorization information 148 defined for one or more users of the vehicle 102 can also be tailored based on context. In this regard, as described above, different users of vehicle 102 can have different usage permissions with respect to whether and which operating functionalities of the vehicle the authorized to utilized following granting of access to the vehicle 102. For instance, one user may be allowed to enter and start the vehicle and utilize the driving functionality of the vehicle (e.g., provided by the driving system 124 while another may only be allowed to enter the vehicle to retrieve something or sit in the vehicle and use the HVAC system 126 and/or one or more other vehicle systems 128 (e.g., the infotainment system for instance and others). To this end, control component 140 can control usage of one or more operating functionalities of the vehicle by respective users of the vehicle based in accordance with their respective reference usage authorization information. For example, based on a determination by the authorization component 138 that a user identity is authorized to utilize a particular operating functionality of the vehicle (e.g., as defined in the reference usage authorization information 148 for the particular user identity), the control component 140 can automatically control activation (or turning on) of the particular operating functionality and/or enable the user to activate, turn on, or otherwise use the particular operating functionality (e.g., via corresponding push buttons or other types of user-machine interface 108 input/control mechanisms for the respective electrical systems of the vehicle) without requiring the user to have a physical vehicle key, key fob or the like.

In addition, the reference usage authorization information 148 defined for a particular user identity of the vehicle 102 can vary based on context, such as vehicle location, time of day, day of week, weather, the external environment of the vehicle, route other contextual factors. For example, the reference usage information 148 defined for a particular user identity may restrict usage of the driving system 124 (and thus driving functionality of the vehicle) of the vehicle to one or more locations, geographical areas, timeframes, weather conditions or the like. In some implementations of the embodiments, the context can also account for route and/or duration of usage. For example, the reference usage information the reference usage information 148 defined for a particular user identity may restrict usage of the driving system 124 to a particular route and/or duration of usage and the control component 140 can control usage of the driving functionality accordingly (e.g., by preventing activation thereof outside the designated route and/or usage duration). The usage permissions can also be tailored to account for various features of the respective operating systems under different contexts and/or for different user identities, such as speed, driving mode (e.g., autonomous driving mode verses automatic driving mode), HVAC settings, infotainment settings, and so on. In some implementations, the usage permissions can also include or correspond to settings regarding preferences of the respective user identities with respect to various features and functionalities of the electrical and/or electromechanical systems of the vehicle 102, and the control component 140 can automatically configure the features and functionalities in accordance with the settings for a given usage scenario or context by an authorized identity. For example, the settings information can relate to settings of any onboard vehicle system or device that can be electronically controlled by the onboard computer system of the vehicle, such as seat position settings, HVAC settings, infotainment settings, navigation/route settings, and so on, which can also be tailored based on context of the vehicle and a particular user identity. In some implementations, the context can also account for the current level of power supply available to the vehicle (e.g., gasoline level and/or battery level for battery operated vehicle). For example, based the reference usage authorization information 146 defined for one or more user identities can restrict or limit usage of one or more operating functionalities of the vehicle 102 and/or the duration of usage thereof (e.g., driving duration, HVAC system usage duration, etc.) based on the level of power supply being low (e.g., relative to one or more defined threshold levels).

To this end, to facilitate controlling vehicle access and usage functionalities for respective user identities based on various contextual factors discussed herein (and others), the context component 212 and determine and monitor the context of the vehicle 102. For example, the context component 212 can determine and/or monitor the vehicle location, time of day/day of week, weather, external environment of the vehicle, route of the vehicle, speed of the vehicle, power supply level of the vehicle and so on. For example, the context component 212 can determine and/or monitor the context of the vehicle based on sensory data captured via the one or more sensors 130, location and/or route information provided by an onboard navigation component 214 (utilizing any suitable location/navigation technology), and integration with the respective vehicle electrical and/or electromechanical systems (e.g., the driving system 124, the HVAC system 126 and the other vehicle systems 128). The context component 212 can also access and employ relevant context information provided by various external resources (e.g., one or more external systems/device 120) as accessed via one or more wired or wireless communication networks. For example, using communication component 220, input/output component 112 and/or antenna 116, the context component 134 can access various, network accessible systems and devices providing relevant information about the vehicle environment, weather conditions, current events, high/low-risk locations, and so on. To this end, communication component 220 can correspond to suitable software and/or hardware employable by the onboard computer system 106 to wirelessly communicate information 118 between the onboard computer system 106 and one or more external systems/devices 120.

In some embodiments, as applied to controlling the driving functionality of vehicle 102, the context can also account for the internal environment of the vehicle and the seat position of the authorized driver. In this regard, in many scenarios, two or more people may enter vehicle 102 following unlocking thereof in response to authorizing unlocking of the main cabin of the vehicle in accordance with the disclosed techniques. However, only one of the people may be authorized to drive the vehicle. With these scenarios, the context component 212 can assess the internal environment of the vehicle (e.g., based on image data captured of the internal environment via one or more cameras) to determine whether the authorized driver is seated in the driver's seat (e.g., using facial recognition technology, or another biometric based identity verification technology). Control component 140 can further restrict the vehicle from being driven (e.g., prevent usage of the driving functionality of the vehicle) based on whether the authorized driver is seated in the driver's seat. For example, control component 140 can prevent the vehicle from being started and driven if the authorized diver is not located in the driver's seat.

As described above, information defining and controlling the security processes (e.g., the one or more entity identification verification processes to be applied by the identification/verification component 136), the user access permissions and the user usage permissions can respectively be defined in the security process data 144, the reference access authorization information 146 and reference usage authorization information 148. In various embodiments, this information can be entered or otherwise generated and stored in memory 114 using security programming component 216. For example, the security programming component 216 can enable one or more authorized entities to define and program, via one or more electronic input devices coupled to the onboard computer system 106, the identity verification process as tailored to the one or more defined identities, the reference identity verification data (e.g., user identity reference biometric data (e.g., reference user facial images, reference user voice signatures, reference user fingerprint signatures, etc.), verification gesture-voice based password data, etc.), the reference access authorization information 146, and the reference usage authorization information 138. For example, in some embodiments, the one or more electronic input devices can include one or more input devices of the human-machine interface and/or coupled to the infotainment system of the vehicle. In another example, the one or more electronic input devices can include any external device (e.g., of external systems/device 120 coupled) coupled to the onboard computer system 106 via any suitable wired or wireless communication technology.

For example, in some implementations, using any suitable input device coupled to the onboard computer system 106, an owner or another authorized user of the vehicle can provide information registering one or more users authorized to access and/or utilize the operating functionalities of the vehicle and provide the reference biometric information for the respective users and their respective user identifiers (e.g., names, usernames, another unique identifier). The authorized user can further enter information defining the applicable entity identification/verification process to be applied (including any contextual variations applicable), their access permissions (including any contextual variations applicable), and their usage permissions (including any contextual variations applicable). For example, in some implementations, using an external device (e.g., an external computer, smartphone or the like), an authorized user located anywhere remote from the vehicle can program the vehicle with such information for a given person to allow any person to access the vehicle and/or use one or more operating functionalities of the vehicle in accordance with the parameters provided and defined by the authorized user. For instance, the authorized user can allow and enable any friend or family member to temporarily access and use the vehicle without having a physical key or key fob for the vehicle. In another example, an authorized user can allow and enable any service personal (e.g., a vehicle repair service, a tow truck service, or the like) to temporarily access and use the vehicle without having a physical key or key fob for the vehicle. In yet another example as applied to rental cars, an authorized rental car operator can allow and enable any vehicle renter to temporarily access and utilize the vehicle for the agreed rental period using the keyless entry and usage functionality techniques described herein.

In some embodiments, in addition to the identification/verification component 136, the authorization component 138, a communication interface component 202, a speed limiter component 204 and geofencing component 206, the computer-executable components 134 can also include the communication interface component 202, the speed limiter component 204, the geofencing component 206, the unlock/lock detection component 210, the context component 212, the navigation component 214, security programming component 216 and communication component 220, the computer-executable components 134 can also include artificial intelligence component 222 (hereinafter AI component 222) and the data can further include tracked user activity data 224. Repetitive description of like elements employed in respective embodiments is omitted for sake of brevity.

In some embodiments, in addition to and/or alternative to having one or more authorized users program the security process data 144, the reference access authorization information 146, and/or reference usage authorization information 148, the AI component 222 can employ various AI and/or machine learning techniques to automatically, learn, generate and adapt this information for respective users of the vehicle based on tracked user activity data 224 for the respective users and other relevant information accessible to the onboard computer system 106 via any suitable wireless communication network (e.g., the Internet) at various relevant data sources. For example, the tracked user activity data 224 can include or correspond to information tracked for one or more authorized users of the vehicle, including their biometric data, their vehicle access activity over time and with respect to various contexts, and the vehicle usage activity over various contexts. The other relevant information sources can include aggregated user activity data for other vehicles under same and disparate contexts, information pertaining to forecasted weather, information pertaining to the current and forecasted environment at the vehicle's current and future location, and other relevant contextual data.

To this end, the AI component 222 can learn the optimal security measures to be applied for respective users under different contexts, the optimal or preferred access permissions and protocols to be applied under different contexts, the optimal or preferred usage permissions to be applied under different contexts and the optimal or preferred user settings with respect to the various features and functionalities of the electronic vehicle systems under different contexts. For example, the AI component 222 can learn, generate, and adapt the reference access authorization information 146 for one or more users based on tracked biometric data captured of respective persons corresponding to the one or more defined identities captured via the one or more sensors 130 and using one or more machine learning techniques. In another example, the AI component 222 can learn, generate, and adapt, the reference usage authorization information 148 based on tracked usage data regarding historical usage of the one or more operating functionalities of the vehicle by the one or more defined identities and using one or more machine learning techniques.

To facilitate this end, the AI component 222 can employ various types of machine learning techniques for learning explicitly or implicitly how to define the identification verification process data 144 for one or more user identities under different contexts, the reference access authorization information 146 for the one or more user identities under different contexts, and the reference usage authorization information 148 for one or more user identities under different contexts. Inferring or learning can employ a probabilistic or statistical-based analysis to infer an action that is to be executed. For example, in some implementations, a support vector machine (SVM) classifier can be employed. Other learning approaches that can be employed by the AI component 222 can include usage of neural networks (e.g., including deep neural networks, deep adversarial neural networks, convolutional neural networks, and the like), Bayesian networks, decision trees, a nearest neighbor algorithms, boosting algorithm, gradient boosting algorithms, linear regression algorithms, k-means clustering algorithms, association rules algorithms, q-learning algorithms, temporal difference algorithm, and probabilistic classification models providing different patterns of independence can be employed. Learning as used herein also is inclusive of statistical regression that is utilized to develop models of priority.

As will be readily appreciated from the subject specification, the subject innovation can employ learning classifiers that are explicitly trained (e.g., via a generic training data) as well as implicitly trained (e.g., via observing user behavior, receiving extrinsic information) so that the learning classifier is used to automatically determine according to predetermined criteria which action to take. For example, SVM's can be configured via a learning or training phase within a learning classifier constructor and feature selection module. A learning classifier is a function that maps an input attribute vector, k=(k1, k2, k3, k4, kn), to a confidence that the input belongs to a learning class—that is, f(k)=confidence(class).

FIG. 3 illustrates a block flow diagram of another example, non-limiting computer-implemented method 300 for controlling vehicle access, in accordance with one or more embodiments described herein. As an example, method 300 can be executed by an electronic computer unit of a vehicle. Method 300 comprises, at 302, receiving, by a system onboard a vehicle (e.g., the communication interface component 202), a command from the driver as the driver exits the vehicle. At 304, defining, by the system (e.g., the speed limiter component 204), a maximum speed value the vehicle can operate based on the received command. At 306, determining, by the system (e.g., the geofencing component 206), a geographic boundary for the vehicle operation based on the received command. At 308, controlling, by the system (e.g., the control component 140), operations of the speed limiter component to activate speed limit and operations of the geofencing component to limit operation of the vehicle within the geographic boundary.

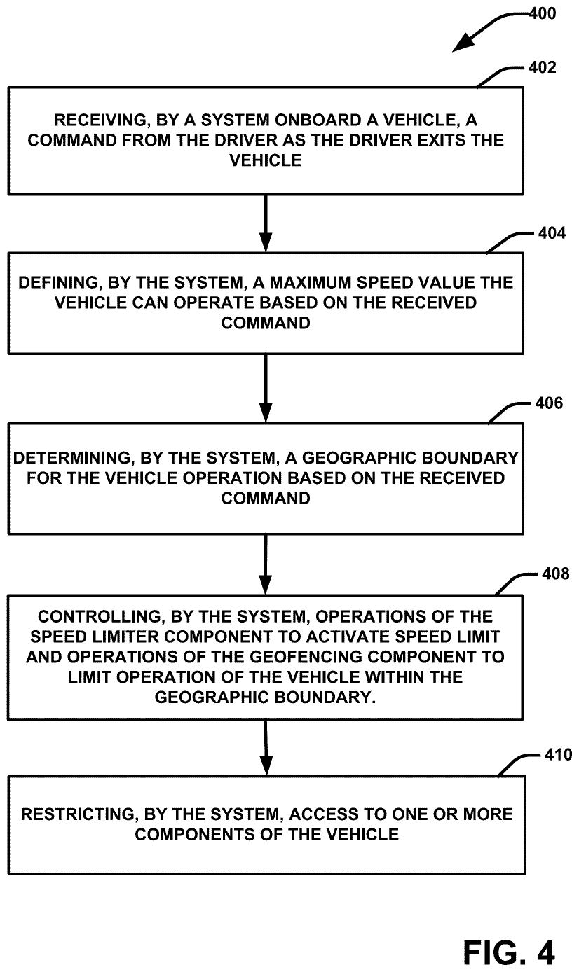

FIG. 4 illustrates a block flow diagram of another example, non-limiting computer-implemented method 400 for controlling vehicle access, in accordance with one or more embodiments described herein. As an example, method 400 can be executed by an electronic computer unit of a vehicle. Method 400 comprises, at 402, receiving, by a system onboard a vehicle (e.g., the communication interface component 202), a command from the driver as the driver exits the vehicle. At 404, defining, by the system (e.g., the speed limiter component 204), a maximum speed value the vehicle can operate based on the received command. At 406, determining, by the system (e.g., the geofencing component 206), a geographic boundary for the vehicle operation based on the received command. At 408, controlling, by the system (e.g., the control component 140), operations of the speed limiter component to activate speed limit and operations of the geofencing component to limit operation of the vehicle within the geographic boundary. At 410, restricting, by the system, access to one or more components of the vehicle.

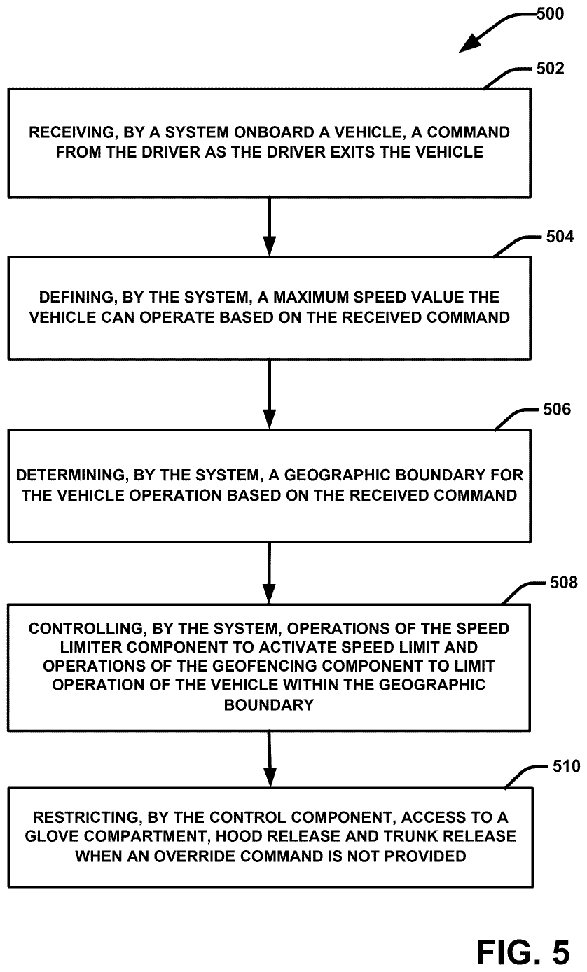

FIG. 5 illustrates a block flow diagram of another example, non-limiting computer-implemented method 500 for controlling vehicle access, in accordance with one or more embodiments described herein. As an example, method 500 can be executed by an electronic computer unit of a vehicle. Method 500 comprises, at 502, receiving, by a system onboard a vehicle (e.g., the communication interface component 202), a command from the driver as the driver exits the vehicle. At 504, defining, by the system (e.g., the speed limiter component 204), a maximum speed value the vehicle can operate based on the received command. At 506, determining, by the system (e.g., the geofencing component 206), a geographic boundary for the vehicle operation based on the received command. At 508, controlling, by the system (e.g., the control component 140), operations of the speed limiter component to activate speed limit and operations of the geofencing component to limit operation of the vehicle within the geographic boundary. At 510, restricting, by the control component, access to a glove compartment, hood release and trunk release when an override command is not provided.

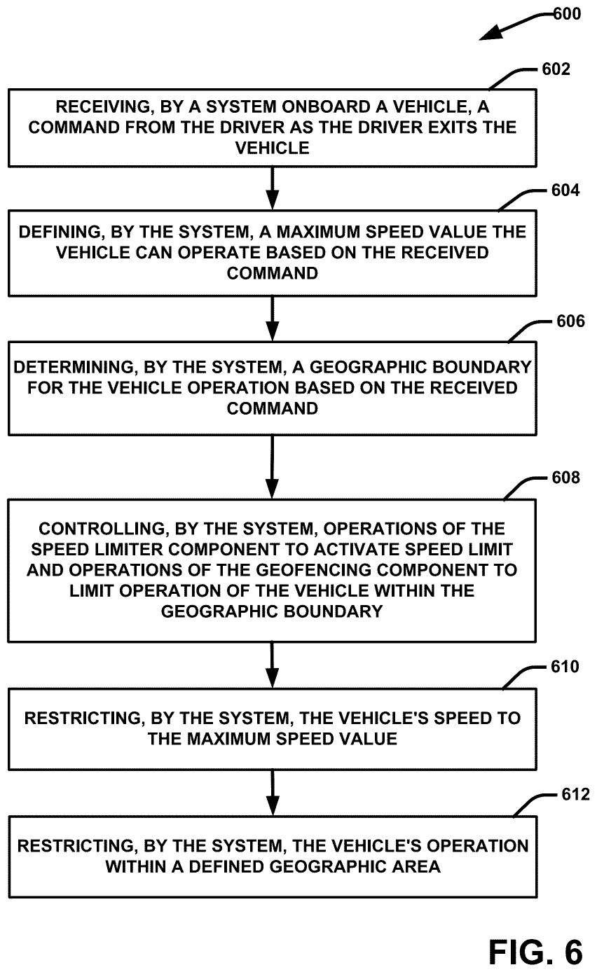

FIG. 6 illustrates a block flow diagram of another example, non-limiting computer-implemented method 600 for controlling vehicle access, in accordance with one or more embodiments described herein. As an example, method 600 can be executed by an electronic computer unit of a vehicle. Method 600 comprises, at 602, receiving, by a system onboard a vehicle (e.g., the communication interface component 202), a command from the driver as the driver exits the vehicle. At 604, defining by the system (e.g., the speed limiter component 204), a maximum speed value the vehicle can operate based on the received command. At 606, determining, by the system (e.g., the geofencing component 206), a geographic boundary for the vehicle operation based on the received command. At 608, controlling, by the system (e.g., the control component 140), operations of the speed limiter component to activate speed limit and operations of the geofencing component to limit operation of the vehicle within the geographic boundary. At 610, restricting, by the system, the vehicle's speed to the maximum speed value. At 612, restricting, by the system, the vehicle's operation within a defined geographic area.

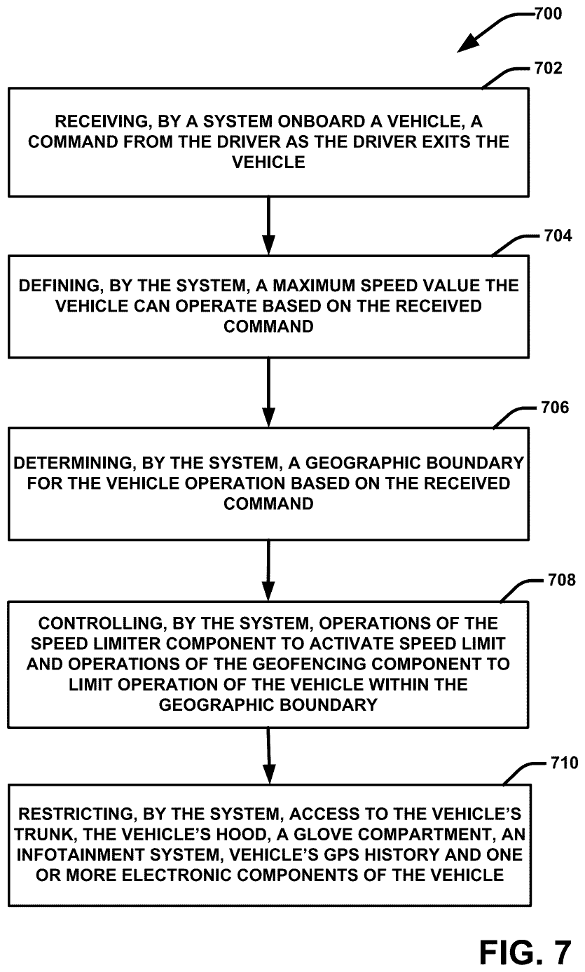

FIG. 7 illustrates a block flow diagram of another example, non-limiting computer-implemented method 700 for controlling vehicle access, in accordance with one or more embodiments described herein. As an example, method 700 can be executed by an electronic computer unit of a vehicle. Method 700 comprises, at 702, receiving, by a system onboard a vehicle (e.g., the communication interface component 202), a command from the driver as the driver exits the vehicle. At 704, defining, by the system (e.g., the speed limiter component 204), a maximum speed value the vehicle can operate based on the received command. At 706, determining, by the system (e.g., the geofencing component 206), a geographic boundary for the vehicle operation based on the received command. At 708, controlling, by the system (e.g., the control component 140), operations of the speed limiter component to activate speed limit and operations of the geofencing component to limit operation of the vehicle within the geographic boundary. At 710, restricting, by the system, access to the vehicle's trunk, the vehicle's hood, a glove compartment, an infotainment system, vehicle's GPS history and one or more electronic components of the vehicle.

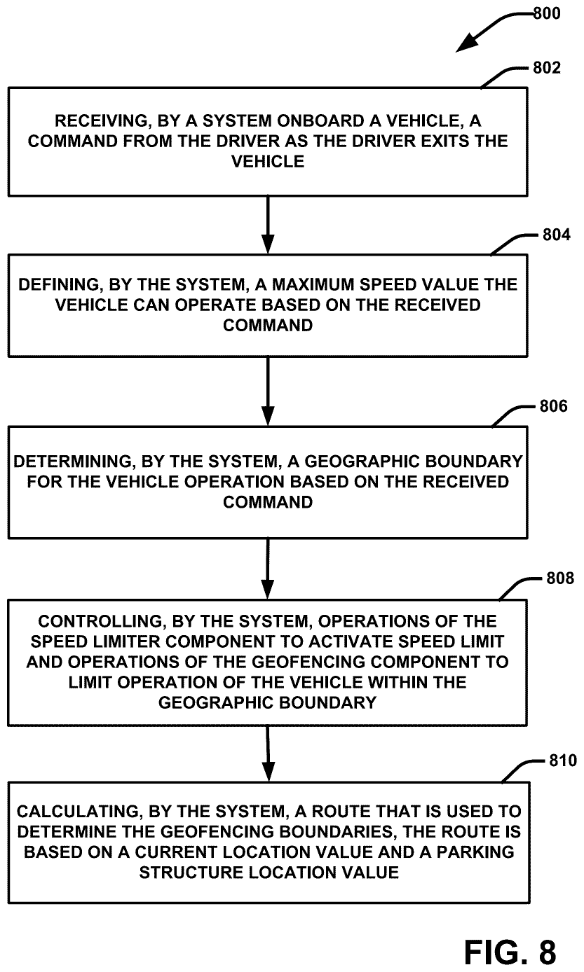

FIG. 8 illustrates a block flow diagram of another example, non-limiting computer-implemented method 800 for controlling vehicle access, in accordance with one or more embodiments described herein. As an example, method 800 can be executed by an electronic computer unit of a vehicle. Method 800 comprises, at 802, receiving, by a system onboard a vehicle (e.g., the communication interface component, a command from the driver as the driver exits the vehicle. At 804, defining by the system (e.g., the speed limiter component 204), a maximum speed value the vehicle can operate based on the received command. At 806, determining, by the system (e.g., the geofencing component 206), a geographic boundary for the vehicle operation based on the received command. At 808, controlling, by the system (e.g., the control component 140), operations of the speed limiter component to activate speed limit and operations of the geofencing component to limit operation of the vehicle within the geographic boundary. At 810, calculating, by the system, a route that is used to determine the geofencing boundaries, the route is based on a current location value and a parking structure location value.

Systems described herein can be coupled (e.g., communicatively, electrically, operatively, optically, inductively, acoustically, etc.) to one or more local or remote (e.g., external) systems, sources, and/or devices (e.g., electronic control systems (ECU), classical and/or quantum computing devices, communication devices, etc.). For example, system 100 (or other systems, controllers, processors, etc.) can be coupled (e.g., communicatively, electrically, operatively, optically, etc.) to one or more local or remote (e.g., external) systems, sources, and/or devices using a data cable (e.g., High-Definition Multimedia Interface (HDMI), recommended standard (RS), Ethernet cable, etc.) and/or one or more wired networks described below.

In some embodiments, systems herein can be coupled (e.g., communicatively, electrically, operatively, optically, inductively, acoustically, etc.) to one or more local or remote (e.g., external) systems, sources, and/or devices (e.g., electronic control units (ECU), classical and/or quantum computing devices, communication devices, etc.) via a network. In these embodiments, such a network can comprise one or more wired and/or wireless networks, including, but not limited to, a cellular network, a wide area network (WAN) (e.g., the Internet), and/or a local area network (LAN). For example, system 100 can communicate with one or more local or remote (e.g., external) systems, sources, and/or devices, for instance, computing devices using such a network, which can comprise virtually any desired wired or wireless technology, including but not limited to: powerline ethernet, VHF, UHF, AM, wireless fidelity (Wi-Fi), BLUETOOTH®, fiber optic communications, global system for mobile communications (GSM), universal mobile telecommunications system (UMTS), worldwide interoperability for microwave access (WiMAX), enhanced general packet radio service (enhanced GPRS), third generation partnership project (3GPP) long term evolution (LTE), third generation partnership project 2 (3GPP2) ultra-mobile broadband (UMB), high speed packet access (HSPA), Zigbee and other 802.XX wireless technologies and/or legacy telecommunication technologies, Session Initiation Protocol (SIP), ZIGBEE®, RF4CE protocol, Wireless HART protocol, L-band voice or data information, 6LoWPAN (IPv6 over Low power Wireless Area Networks), Z-Wave, an ANT, an ultra-wideband (UWB) standard protocol, and/or other proprietary and non-proprietary communication protocols. In this example, system 100 can thus include hardware (e.g., a central processing unit (CPU), a transceiver, a decoder, an antenna (e.g., a ultra-wideband (UWB) antenna, a BLUETOOTH® low energy (BLE) antenna, etc.), quantum hardware, a quantum processor, etc.), software (e.g., a set of threads, a set of processes, software in execution, quantum pulse schedule, quantum circuit, quantum gates, etc.), or a combination of hardware and software that facilitates communicating information between a system herein and remote (e.g., external) systems, sources, and/or devices (e.g., computing and/or communication devices such as, for instance, a smart phone, a smart watch, wireless earbuds, etc.).

Systems herein can comprise one or more computer and/or machine readable, writable, and/or executable components and/or instructions that, when executed by processor (e.g., a processing unit 110 which can comprise a classical processor, a quantum processor, etc.), can facilitate performance of operations defined by such component(s) and/or instruction(s). Further, in numerous embodiments, any component associated with a system herein, as described herein with or without reference to the various figures of the subject disclosure, can comprise one or more computer and/or machine readable, writable, and/or executable components and/or instructions that, when executed by a processor, can facilitate performance of operations defined by such component(s) and/or instruction(s). Consequently, according to numerous embodiments, system herein and/or any components associated therewith as disclosed herein, can employ a processor (e.g., processing unit 116) to execute such computer and/or machine readable, writable, and/or executable component(s) and/or instruction(s) to facilitate performance of one or more operations described herein with reference to system herein and/or any such components associated therewith.

Systems herein can comprise any type of system, device, machine, apparatus, component, and/or instrument that comprises a processor and/or that can communicate with one or more local or remote electronic systems and/or one or more local or remote devices via a wired and/or wireless network. All such embodiments are envisioned. For example, a system (e.g., a system 100 or any other system or device described herein) can comprise a computing device, a general-purpose computer, field-programmable gate array, AI accelerator application-specific integrated circuit, a special-purpose computer, an onboard computing device, a communication device, an onboard communication device, a server device, a quantum computing device (e.g., a quantum computer), a tablet computing device, a handheld device, a server class computing machine and/or database, a laptop computer, a notebook computer, a desktop computer, wearable device, internet of things device, a cell phone, a smart phone, a consumer appliance and/or instrumentation, an industrial and/or commercial device, a digital assistant, a multimedia Internet enabled phone, a multimedia players, and/or another type of device.

In order to provide additional context for various embodiments described herein, FIG. 9 and the following discussion are intended to provide a brief, general description of a suitable computing environment 900 in which the various embodiments of the embodiment described herein can be implemented. While the embodiments have been described above in the general context of computer-executable instructions that can run on one or more computers, those skilled in the art will recognize that the embodiments can be also implemented in combination with other program modules and/or as a combination of hardware and software.

Generally, program modules include routines, programs, components, data structures, etc., that perform particular tasks or implement particular abstract data types. Moreover, those skilled in the art will appreciate that the various methods can be practiced with other computer system configurations, including single-processor or multiprocessor computer systems, minicomputers, mainframe computers, Internet of Things (IoT) devices, distributed computing systems, as well as personal computers (e.g., ruggedized personal computers), field-programmable gate arrays, hand-held computing devices, microprocessor-based or programmable consumer electronics, and the like, each of which can be operatively coupled to one or more associated devices.

The illustrated embodiments of the embodiments herein can also be practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data, or unstructured data.

Computer-readable storage media can include, but are not limited to, random access memory (RAM), read only memory (ROM), electrically erasable programmable read only memory (EEPROM), flash memory or other memory technology, compact disk read only memory (CD ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory, or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries, or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, optic, infrared, and other wireless media.

With reference again to FIG. 9, the example environment 900 for implementing various embodiments of the aspects described herein includes a computer 902, the computer 902 including a processing unit 904, a system memory 906 and a system bus 908. The system bus 908 couples system components including, but not limited to, the system memory 906 to the processing unit 904. The processing unit 904 can be any of various commercially available processors, field-programmable gate array, AI accelerator application-specific integrated circuit, or other suitable processors. Dual microprocessors and other multi-processor architectures can also be employed as the processing unit 904.

The system bus 908 can be any of several types of bus structure that can further interconnect to a memory bus (with or without a memory controller), a peripheral bus, and a local bus using any of a variety of commercially available bus architectures. System memory 906 includes ROM 910 and RAM 912. A basic input/output system (BIOS) can be stored in a non-volatile memory such as ROM, erasable programmable read only memory (EPROM), EEPROM, which BIOS contains the basic routines that help to transfer information between elements within the computer 902, such as during startup. The RAM 912 can also include high-speed RAM such as static RAM for caching data. It is noted that unified Extensible Firmware Interface(s) can be utilized herein.

The computer 902 further includes an internal hard disk drive (HDD) 914 (e.g., EIDE, SATA), one or more external storage devices 916 (e.g., a magnetic floppy disk drive (FDD) 916, a memory stick or flash drive reader, a memory card reader, etc.) and an optical disk drive 920 (e.g., which can read or write from a disc 922 such as a CD-ROM disc, a DVD, a BD, etc.). While the internal HDD 914 is illustrated as located within the computer 902, the internal HDD 914 can also be configured for external use in a suitable chassis (not shown). Additionally, while not shown in environment 900, a solid-state drive (SSD) could be used in addition to, or in place of, an HDD 914. The HDD 914, external storage device(s) 916 and optical disk drive 920 can be connected to the system bus 908 by an HDD interface 924, an external storage interface 926 and an optical drive interface 928, respectively. The interface 924 for external drive implementations can include at least one or both Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 902, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 912, including an operating system 930, one or more application programs 932, other program modules 934 and program data 936. All or portions of the operating system, applications, modules, and/or data can also be cached in the RAM 912. The systems and methods described herein can be implemented utilizing various commercially available operating systems or combinations of operating systems.

Computer 902 can optionally comprise emulation technologies. For example, a hypervisor (not shown) or other intermediary can emulate a hardware environment for operating system 930, and the emulated hardware can optionally be different from the hardware illustrated in FIG. 9. In such an embodiment, operating system 930 can comprise one virtual machine (VM) of multiple VMs hosted at computer 902. Furthermore, operating system 930 can provide runtime environments, such as the Java runtime environment or the. NET framework, for applications 932. Runtime environments are consistent execution environments that allow applications 932 to run on any operating system that includes the runtime environment. Similarly, operating system 930 can support containers, and applications 932 can be in the form of containers, which are lightweight, standalone, executable packages of software that include, e.g., code, runtime, system tools, system libraries and settings for an application.

Further, computer 902 can be enabled with a security module, such as a trusted processing module (TPM). For instance, with a TPM, boot components hash next in time boot components and wait for a match of results to secured values, before loading a next boot component. This process can take place at any layer in the code execution stack of computer 902, e.g., applied at the application execution level or at the operating system (OS) kernel level, thereby enabling security at any level of code execution.

A user can enter commands and information into the computer 902 through one or more wired/wireless input devices, e.g., a keyboard 938, a touch screen 940, and a pointing device, such as a mouse 942. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 904 through an input device interface 944 that can be coupled to the system bus 908, but can be connected by other interfaces, such as a parallel port, an IEEE 1394 serial port, a game port, a USB port, an IR interface, a BLUETOOTH® interface, etc.

A monitor 946 or other type of display device can also be connected to the system bus 908 via an interface, such as a video adapter 948. In addition to the monitor 946, a computer typically includes other peripheral output devices (not shown), such as speakers, printers, etc.

The computer 902 can operate in a networked environment using logical connections via wired and/or wireless communications to one or more remote computers, such as a remote computer(s) 950. The remote computer(s) 950 can be a workstation, a server computer, a router, a personal computer, portable computer, microprocessor-based entertainment appliance, a peer device or other common network node, and typically includes many or all of the elements described relative to the computer 902, although, for purposes of brevity, only a memory/storage device 952 is illustrated. The logical connections depicted include wired/wireless connectivity to a local area network (LAN) 954 and/or larger networks, e.g., a wide area network (WAN) 956. Such LAN and WAN networking environments are commonplace in offices and companies, and facilitate enterprise-wide computer networks, such as intranets, all of which can connect to a global communications network, e.g., the Internet.

When used in a LAN networking environment, the computer 902 can be connected to the local network 954 through a wired and/or wireless communication network interface or adapter 958. The adapter 958 can facilitate wired or wireless communication to the LAN 954, which can also include a wireless access point (AP) disposed thereon for communicating with the adapter 958 in a wireless mode.

When used in a WAN networking environment, the computer 902 can include a modem 960 or can be connected to a communications server on the WAN 956 via other means for establishing communications over the WAN 956, such as by way of the Internet. The modem 960, which can be internal or external and a wired or wireless device, can be connected to the system bus 908 via the input device interface 944. In a networked environment, program modules depicted relative to the computer 902 or portions thereof, can be stored in the remote memory/storage device 952. It will be appreciated that the network connections shown are examples and other means of establishing a communications link between the computers can be used.

When used in either a LAN or WAN networking environment, the computer 902 can access cloud storage systems or other network-based storage systems in addition to, or in place of, external storage devices 916 as described above. Generally, a connection between the computer 902 and a cloud storage system can be established over a LAN 954 or WAN 956 e.g., by the adapter 958 or modem 960, respectively. Upon connecting the computer 902 to an associated cloud storage system, the external storage interface 926 can, with the aid of the adapter 958 and/or modem 960, manage storage provided by the cloud storage system as it would other types of external storage. For instance, the external storage interface 926 can be configured to provide access to cloud storage sources as if those sources were physically connected to the computer 902.

The computer 902 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

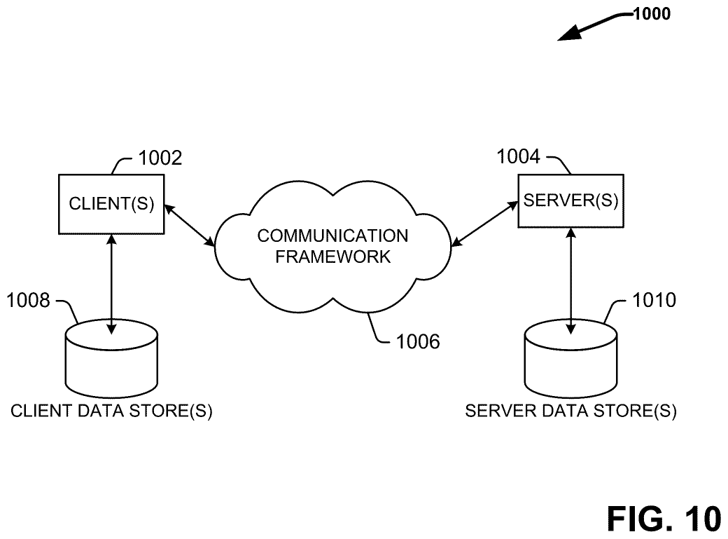

Referring now to FIG. 10, there is illustrated a schematic block diagram of a computing environment 1000 in accordance with this specification. The system 1000 includes one or more client(s) 1002, (e.g., computers, smart phones, tablets, cameras, PDA's). The client(s) 1002 can be hardware and/or software (e.g., threads, processes, computing devices). The client(s) 1002 can house cookie(s) and/or associated contextual information by employing the specification, for example.

The system 1000 also includes one or more server(s) 1004. The server(s) 1004 can also be hardware or hardware in combination with software (e.g., threads, processes, computing devices). The servers 1004 can house threads to perform transformations of media items by employing aspects of this disclosure, for example. One possible communication between a client 1002 and a server 1004 can be in the form of a data packet adapted to be transmitted between two or more computer processes wherein data packets may include coded analyzed headspaces and/or input. The data packet can include a cookie and/or associated contextual information, for example. System 1000 includes a communication framework 1006 (e.g., a global communication network such as the Internet) that can be employed to facilitate communications between the client(s) 1002 and the server(s) 1004.

Communications can be facilitated via a wired (including optical fiber) and/or wireless technology. The client(s) 1002 are operatively connected to one or more client data store(s) 1008 that can be employed to store information local to the client(s) 1002 (e.g., cookie(s) and/or associated contextual information). Similarly, the server(s) 1004 are operatively connected to one or more server data store(s) 1010 that can be employed to store information local to the servers 1004. Further, the client(s) 1002 can be operatively connected to one or more server data store(s) 1010.

In one exemplary implementation, client 1002 can transfer an encoded file, (e.g., encoded media item), to server 1004. Server 1004 can store the file, decode the file, or transmit the file to another client 1002. It is noted that a client 1002 can also transfer uncompressed files to a server 1004 and server 1004 can compress the file and/or transform the file in accordance with this disclosure. Likewise, server 1004 can encode information and transmit the information via communication framework 1006 to one or more clients 1002.

The illustrated aspects of the disclosure can also be practiced in distributed computing environments where certain tasks are performed by remote processing devices that are linked through a communications network. In a distributed computing environment, program modules can be located in both local and remote memory storage devices.

The above description includes non-limiting examples of the various embodiments. It is, of course, not possible to describe every conceivable combination of components or methods for purposes of describing the disclosed subject matter, and one skilled in the art can recognize that further combinations and permutations of the various embodiments are possible. The disclosed subject matter is intended to embrace all such alterations, modifications, and variations that fall within the spirit and scope of the appended claims.

With regard to the various functions performed by the above-described components, devices, circuits, systems, etc., the terms (including a reference to a “means”) used to describe such components are intended to also include, unless otherwise indicated, any structure(s) which performs the specified function of the described component (e.g., a functional equivalent), even if not structurally equivalent to the disclosed structure. In addition, while a particular feature of the disclosed subject matter may have been disclosed with respect to only one of several implementations, such feature can be combined with one or more other features of the other implementations as may be desired and advantageous for any given or particular application.

The terms “exemplary” and/or “demonstrative” as used herein are intended to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent structures and techniques known to one skilled in the art. Furthermore, to the extent that the terms “includes,” “has,” “contains,” and other similar words are used in either the detailed description or the claims, such terms are intended to be inclusive—in a manner similar to the term “comprising” as an open transition word—without precluding any additional or other elements.

The term “or” as used herein is intended to mean an inclusive “or” rather than an exclusive “or. ” For example, the phrase “A or B” is intended to include instances of A, B, and both A and B. Additionally, the articles “a” and “an” as used in this application and the appended claims should generally be construed to mean “one or more” unless either otherwise specified or clear from the context to be directed to a singular form.

The term “set” as employed herein excludes the empty set, i.e., the set with no elements therein. Thus, a “set” in the subject disclosure includes one or more elements or entities. Likewise, the term “group”as utilized herein refers to a collection of one or more entities.

The description of illustrated embodiments of the subject disclosure as provided herein, including what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as one skilled in the art can recognize. In this regard, while the subject matter has been described herein in connection with various embodiments and corresponding drawings, where applicable, it is to be understood that other similar embodiments can be used or modifications and additions can be made to the described embodiments for performing the same, similar, alternative, or substitute function of the disclosed subject matter without deviating therefrom. Therefore, the disclosed subject matter should not be limited to any single embodiment described herein, but rather should be construed in breadth and scope in accordance with the appended claims below.

Further aspects of the invention are provided by the subject matter of the following clauses:
1. A system, comprising: one or more sensors integrated on or within a vehicle; a memory that stores computer executable components; and a processor that executes the computer executable components stored in the memory, wherein the computer executable components comprise: a communication interface component that receives a command from the driver as the driver exits the vehicle; a speed limiter component that defines a maximum speed value the vehicle can operate based on the received command; a geofencing component that defines geographic boundaries for the vehicle operation based on the received command; and a control component operatively connected to the communication interface component, speed limiter component and the geofencing component, wherein the control component activates the speed limiter component to utilizes the maximum speed value and activates the geofencing component to determine the geofencing boundaries to limit the functionality of the vehicle based on the driver's command.
2. The system of one or more preceding claims, wherein the control component restricts access to one or more components of the vehicle.
3. The system of one or more preceding claims, wherein the control component restricts access to a glove compartment, hood release and trunk release when an override command is not provided.
4. The system of one or more preceding claims, the control component further restricts access to the vehicle's trunk, the vehicle's hood, a glove compartment, an infotainment system, vehicle's GPS history and one or more electronic components of the vehicle.
5. The system of one or more preceding claims, the control component uses the maximum speed value set maximum speed to 15 miles per hour without receiving an override command.
6. The system of one or more preceding claims, the geofencing component calculates a route that is used to determine the geofencing boundaries, the route is based on a current location value and a parking structure location value.
7. The system of one or more preceding claims, the communication interface component further receives the override command to temporarily increase the maximum speed value.
8. The system of one or more preceding claims, wherein the control component further controls access to the one or more internal compartments via electronically controlling unlocking and locking of an enclosure of the one or more internal compartments in accordance with an access authorization information determined based on the command.
9. The system of one or more preceding claims, wherein the control component deactivates the speed limiter component and geofencing component upon receiving a deactivation signal from the communication interface component.
10. The system of one or more preceding claims further comprising: a sensor component to determine when the driver has exited the vehicle.
11. A method, comprising: receiving, by a communication interface component, a command from the driver as the driver exits the vehicle; defining, by a speed limiter component, a maximum speed value the vehicle can operate based on the received command; determining, by a geofencing component, a geographic boundary for the vehicle operation based on the received command; and controlling, by a control component operatively connected to the communication interface component, speed limiter component and the geofencing component, operations of the speed limiter component to activate speed limit and operations of the geofencing component to limit operation of the vehicle within the geographic boundary.
12. The method of one or more preceding clauses further comprising: restricting, by the control component, access to one or more components of the vehicle.
13. The method of one or more preceding clauses further comprising: restricting, by the control component, access to a glove compartment, hood release and trunk release when an override command is not provided.
14. The method of one or more preceding clauses, wherein the command comprises a “valet”phrase.
15. The method of one or more preceding clauses, further comprising: restricting, by the speed limiter, the vehicle's speed to the maximum speed value; and restricting, by the geofencing component, the vehicle's operation within a defined geographic area.
16. The method of one or more preceding clauses, further comprising: restricting, by the control component, access to the vehicle's trunk, the vehicle's hood, a glove compartment, an infotainment system, vehicle's GPS history and one or more electronic components of the vehicle.
17. The method of one or more preceding clauses further comprising: calculating, by the geofencing component, a route that is used to determine the geofencing boundaries, the route is based on a current location value and a parking structure location value.
18. A non-transitory machine-readable storage medium, comprising executable instructions that, when executed by a processor integrated on or within a vehicle, facilitate performance of operations, comprising: receiving a command from the driver as the driver exits the vehicle; defining a maximum speed value the vehicle can operate based on the received command; determining a geographic boundary for the vehicle operation based on the received command; and controlling operations of the speed limiter component to activate speed limit and operations of the geofencing component to limit operation of the vehicle within the geographic boundary.
19. The non-transitory machine-readable storage medium of one or more preceding clauses, further comprising: restricting the vehicle's speed to the maximum speed value; and restricting, by the geofencing component, the vehicle's operation within a defined geographic area.
20. The non-transitory machine-readable storage medium of one or more preceding clauses further comprising: restricting access to the vehicle's trunk, the vehicle's hood, a glove compartment, an infotainment system, vehicle's GPS history and one or more electronic components of the vehicle.
21. Any suitable combinations of clauses 1-10.
22. Any suitable combination of clauses 11-17.
23. Any suitable combination of clauses 18-20.
24. Any suitable combination of clauses 1-20.

What is claimed is:

1. A system, comprising:
one or more sensors integrated on or within a vehicle;
a memory that stores computer executable components; and
a processor that executes the computer executable components stored in the memory, wherein the computer executable components comprise:
a communication interface component that receives a command from the driver as the driver exits the vehicle;
a speed limiter component that defines a maximum speed value the vehicle can operate based on the received command;
a geofencing component that defines geographic boundaries for the vehicle operation based on the received command; and
a control component operatively connected to the communication interface component, speed limiter component and the geofencing component, wherein the control component activates the speed limiter component to utilizes the maximum speed value and activates the geofencing component to determine the geofencing boundaries to limit the functionality of the vehicle based on the driver's command.

2. The system of claim 1, wherein the control component restricts access to one or more components of the vehicle.

3. The system of claim 2, wherein the control component restricts access to a glove compartment, hood release and trunk release when an override command is not provided.

4. The system of claim 2, the control component further restricts access to the vehicle's trunk, the vehicle's hood, a glove compartment, an infotainment system, vehicle's GPS history and one or more electronic components of the vehicle.

5. The system of claim 1, the control component uses the maximum speed value set maximum speed to 15 miles per hour without receiving an override command.

6. The system of claim 1, the geofencing component calculates a route that is used to determine the geofencing boundaries, the route is based on a current location value and a parking structure location value.

7. The system of claim 1, the communication interface component further receives the override command to temporarily increase the maximum speed value.

8. The system of claim 1, wherein the control component further controls access to the one or more internal compartments via electronically controlling unlocking and locking of an enclosure of the one or more internal compartments in accordance with an access authorization information determined based on the command.

9. The system of claim 7, wherein the control component deactivates the speed limiter component and geofencing component upon receiving a deactivation signal from the communication interface component.

10. The system of claim 1, further comprising:
a sensor component to determine when the driver has exited the vehicle.

11. A method, comprising:
receiving, by a communication interface component, a command from the driver as the driver exits the vehicle;
defining, by a speed limiter component, a maximum speed value the vehicle can operate based on the received command;
determining, by a geofencing component, a geographic boundary for the vehicle operation based on the received command; and
controlling, by a control component operatively connected to the communication interface component, speed limiter component and the geofencing component, operations of the speed limiter component to activate speed limit and operations of the geofencing component to limit operation of the vehicle within the geographic boundary.

12. The method of claim 11, further comprising:
restricting, by the control component, access to one or more components of the vehicle.

13. The method of claim 11, further comprising:
restricting, by the control component, access to a glove compartment, hood release and trunk release when an override command is not provided.

14. The method of claim 13, wherein the command comprises a “valet” phrase.

15. The method of claim 11, further comprising:
restricting, by the speed limiter, the vehicle's speed to the maximum speed value; and
restricting, by the geofencing component, the vehicle's operation within a defined geographic area.

16. The method of claim 11, further comprising:
restricting, by the control component, access to the vehicle's trunk, the vehicle's hood, a glove compartment, an infotainment system, vehicle's GPS history and one or more electronic components of the vehicle.

17. The method of claim 11, further comprising:
calculating, by the geofencing component, a route that is used to determine the geofencing boundaries, the route is based on a current location value and a parking structure location value.

18. A non-transitory machine-readable storage medium, comprising executable instructions that, when executed by a processor integrated on or within a vehicle, facilitate performance of operations, comprising:
receiving a command from the driver as the driver exits the vehicle;
defining a maximum speed value the vehicle can operate based on the received command;
determining a geographic boundary for the vehicle operation based on the received command; and
controlling operations of the speed limiter component to activate speed limit and operations of the geofencing component to limit operation of the vehicle within the geographic boundary.

19. The non-transitory machine-readable storage medium of claim 18, further comprising:
restricting the vehicle's speed to the maximum speed value; and
restricting, by the geofencing component, the vehicle's operation within a defined geographic area.

20. The non-transitory machine-readable storage medium of claim 18, further comprising:
restricting access to the vehicle's trunk, the vehicle's hood, a glove compartment, an infotainment system, vehicle's GPS history and one or more electronic components of the vehicle.
